(19) United States
(12) Patent Application Publication
(10) Pub. No.: US 2026/0309492 A1
(43) Pub. Date: Oct. 8, 2026

(54) Tri Outward Swivel Vial Level

(71) Applicant: Hugo Rodriguez, El Paso, TX (US)

(72) Inventor: Hugo Rodriguez, El Paso, TX (US)

(21) Appl. No.: 19/171,090

(22) Filed: Apr. 4, 2025

(51) Int. Cl. G01C 9/28; G01C 9/34

(52) U.S. Cl. CPC G01C 9/28; G01C 9/34

(57) ABSTRACT

A level apparatus with a joining swivel out component (10) and vials (2,9,3) of the type comprising in combination with the base (1) of a spirit level, wherein the swivel outward vial component (10) has a 360° view from all sides (6A, 6B, 6C, 6D, 6E, 6F) in which it can be maneuvered by a ball bearing or pin tool (5). Currently, there are many level types for all types of industries, but the benefit of the invention would be for mechanical tradesman who work in tight high working spaces that are not easily accessible. There are challenges and dangerous situations where mechanical tradesmen are positioned in tight spaces and leaves little room for mistakes, this invention would allow many to complete the task safely due to the main element that allows the 0° vial to swing outward (10) at a 360-degree angle (5).

### CROSS REFERENCE TO RELATED APPLICATIONS

The present application claims priority to, and the benefit of, U.S. Provisional Application No. 63/708,636, which was filed on Oct. 17, 2024, and is incorporated herein by reference in its entirety.

### FIELD OF THE INVENTION

The present invention relates to spirit levels and particularly to a spirit level with a outward swivel component

### BACKGROUND

Example embodiments in general relate to levels and more specifically it relates to a tri-swivel outward vial level. Many mechanical tradesmen are called out to repair, install, replace and even provide various systems and equipment. Many mechanical tradesmen find themselves in tight spaces working on high ceilings installing, repairing or constructing of 6 feet or more. In this industry a major challenge is trying to juggle multiple moving parts, including different levelling tools, especially within a tight space of less than 1-2 feet wide, with limited visibility. Currently many levels have been used, but in order to achieve a precise errorless level, 2 or more tradesmen currently are needed. The current issue is that there are no levels that exists where it allows the center of level to be pulled out and moved in a 360-degree angle, within its position and viewed in different directions.

### SUMMARY OF THE INVENTION

The following presents itself as a simplified understanding of the disclosed innovation present. This summary is not an extensive overview and it is not intended to identify the key elements. Its purpose is to present the general concepts of the tri-swivel outward vial level. An example embodiment of the present invention is directed from a level which includes the main elements of the invention the tri-outward swivel vial component, that can swing outward and can be viewed in multifaceted prospective. The invention will assist with measuring, adjusting and aligning using only one mechanical tradesmen. The invention itself would eliminate the need for using more time, money, and labor cost by not having two mechanical tradesmen use unnecessary time and effort when it can be done smoothly and effectively by one mechanical tradesman. This tri-outward swivel level would help an individual to use the magnet area in which it will stick to the metal object and the center of the tri-outward swivel level can be rotated outward in a 360-degree angle. This allows visibility in all directions, the goal of attaining the perfect balance when it comes to tight spaces that are now easily accessible with the invention. Currently, no tri-outward swivel level exists in which this would help with safety, time and cost. At this time, it takes 2 or more tradesmen to work together to balance, especially in tight high obscured spaces. Many mechanical tradesmen work in very elevated tight spaces where they have little room to work in. The tri outward swivel level will prevent injuries and damages to hazardous congested elevated spaces. It will also assist with eliminating any OSHA violations.

### BRIEF DESCRIPTION OF THE DRAWINGS

I, Hugo Rodriguez, have invented a new design to be added to a level, as set forth in the following specification. The claimed tri outward swivel vial level is used for balancing a level in all areas but especially for tight spaces. The example embodiments will become more fully understood from the detailed description given herein below and the accompanying drawings, wherein like elements are represented by like reference characters, which are given by way of illustration only and thus are not limitative of the example embodiments herein.

FIG. 1 is a perspective front view that illustrates the parts of the main standard basic level base. This example is for illustration only and will be showing a 12″ level, where vials are housed within a compartment chamber. The first compartment chamber shows an attached example of a 1 ⅜″ space with a 90° vial. The second compartment chamber example is 1 ⅜″ with a 0° vial that is attached and unmovable. The third is an example of a 2 ½″ compartment chamber with a 0° vial that is attached to a pin or ball-bearing 360° rotating bearing. The last piece is 45° non-movable compartment.

FIG. 2 is the example of a top view of the tri-outward vial level with a partially covered sectioned for all vial compartment components, except the adjustable swivel outward compartment. The view is from the top for a clear all vial visibility (10).

FIG. 3 illustrates a view from below or bottom, it supports FIG. 2 with the angle compartments, which will be covered (7) and not viewed from the bottom, but shows the sample tri-outward swivel vial compartment which will be pulled outward to be viewed in all directions (10). It also illustrates the example of earth magnets to be placed for hold support.

FIG. 4 with reference to FIG. 3 illustrates a 3D view of the swivel out vial component chamber. It depicts an example of the clear-way view of all sides. This includes the length of the parallel and right and left angle width.

FIG. 5 illustrates the perspective side view of the outward vial component chamber, it which can be seen clearer all side views which pulled out when in use.

### DETAILED DESCRIPTION OF A PREFERRED EMBODIMENT

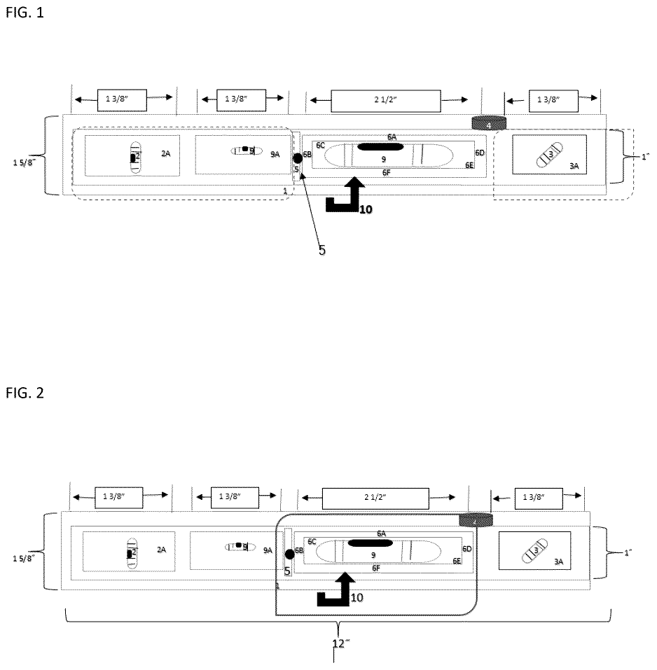

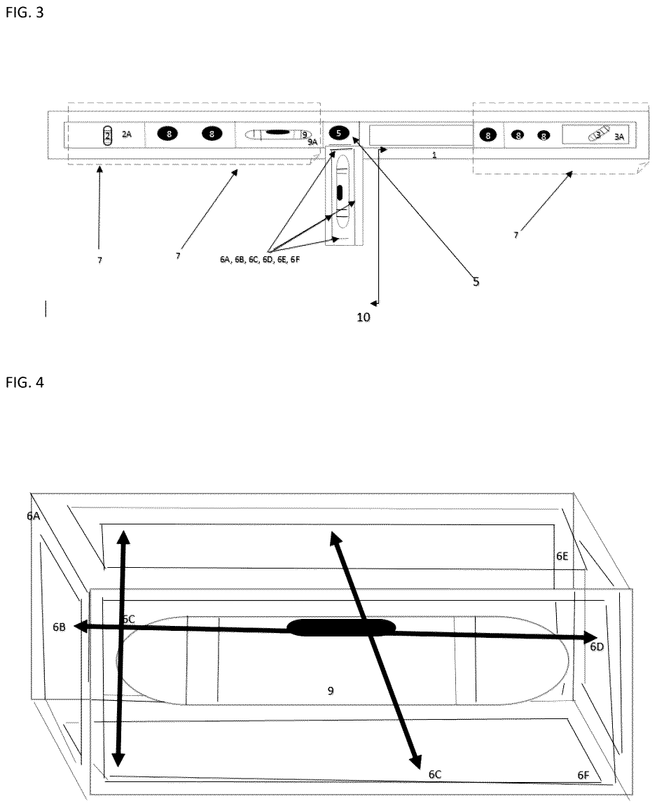

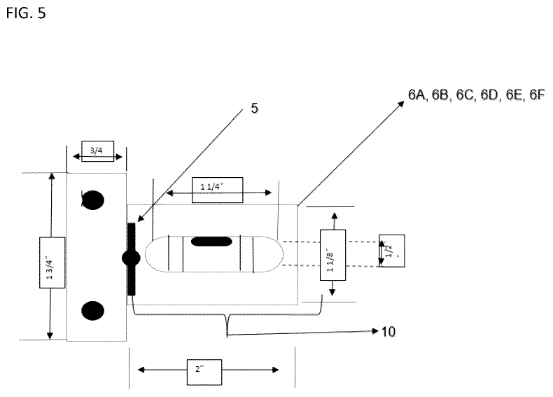

I do hereby declare the following to be a clear, full and exact description of the invention. Such as this will of invention will enable others skilled in the art to which it operates to. My invention consists of a certain feature and details of mechanical industry tradesmen in the construction field as fully described in the specification and pointed out in the claims. The main object of the present invention is to improve the current object that has been produce. My invention is produced as a simple inexpensive device and yet one which will exceed effective for the purpose of which is designed. Reference is now made to FIGS. 1 and 2 which illustrate a spirit level (12) constructed and operative in accordance with a preferred embodiment of the present invention. Spirit level (12) preferably includes a body (1) having one or more level faces (2, 9, 3) for each component compartment (2A, 9A, 10, 3A). Body (1) is preferably made of a mechanically stable and durable metal alloy, or aluminum, as is well known in the art. Level component (2A, 9A, 3A) is created through specific cuts that are milled into the body and is typically has highly accurate flatness and smoothness. The vials will be filled with fluorescent readable fluid as is now. End caps, typically made of plastic, may be fixed to ends of body (not shown in art). FIG. 3. Illustrates the body of the Spirit level (1) but has a hollow box compartment in which shows a unique vial center that takes the design from a regular spirit level. The unique bubble vial rotates 360° when it swings and pivots outward for a clear-way view (10). FIG. 4 illustrates the detailed bubble vial in which is located in an all-view box. (6A, 6B, 6C, 6D, 6E, 6F) Generally spirit levels only have a front, back or top view, but currently no spirit level has a component that pivots and swivels out to face the viewer at a 360°view.

1. A specialized leveling tool Tri Outward Swivel Vial Level used to determine whether a surface is horizontal (level) or vertical (plumb), comprising:
a main housing body divided into compartments that house vials within their individual compartments; a main compartment component that is placed in the levelling tool;
a main compartment component with a bubble vial that swivels, pivots and rotates outward as described and shown.

2. A Tri Outward Swivel Vial Level as in claim 1 further comprising:
a swivel piece controlled by a pin or a ball bearing movement, in which can be viewed at a 360° view as described and shown;
a main component vial connected to the swivel piece that holds the vial can be seen in all sides for a clear view.
